(19) United States
(12) Patent Application Publication
(10) Pub. No.: US 2005/0249882 A1
(43) Pub. Date: Nov. 10, 2005

(54) Coatings for molecule transport and separations

(76) Inventors: Shaorong Liu, Lubbock, TX (US); Juan Lu, Lubbock, TX (US)

Correspondence Address: LIU, SHAORONG, 5504 71ST STREET, LUBBOCK, TX, 79424, US

(21) Appl. No.: 11/119,603

(22) Filed: May 2, 2005

Related U.S. Application Data
(60) Provisional application No. 60/568,025, filed on May 4, 2004.

(51) Int. Cl. B05D 3/04; B05D 1/36

(52) U.S. Cl. 427/402; 427/302

(57) ABSTRACT

A process is disclosed for coating the inner surface of a solid support (e.g. a capillary or a microchip channel) to reduce the analyte adsorption to the surface for separating components in a fluid stream in contact with the surface. The process comprises (a) covalently binding a bi-functional reagent to the support surface, (b) mixing the monomer with a radical initiator under an oxygen-removed environment; and (c) rapidly bringing the above mixture solution to the functionalized surface under an oxygen-free environment.

This patent application claims the benefit under 35 U.S.C. § 119(e) of U.S. provisional patent application Ser. No. 60/568,025, filed on May 4, 2004.

### BACKGROUND OF THE INVENTION

1. Field of the Invention

The present invention relates generally to modifications of a solid support surface for conducting molecular transportation, chemical reaction and/or bio-separation, and diagnostics and/or analysis related thereto, and more particularly, to capillary electrophoretic separations of biomolecules.

2. Description of Related Art

Capillary electrophoresis (CE) has become a powerful analytical technique in recent years due to its high efficiency, short separation time, minimum consumption of sample and reagent, and ease of automation. Its utility has been demonstrated in separations ranging from small molecules, such as inorganic/organic ions, amino acids, and peptides, to biopolymers, including proteins and DNA. CE is projected to play a vital role in proteomics research; however, the separation of proteins by CE is not straightforward. Silanol groups on the surface of fused-silica capillaries greatly increase band broadening and peak tailing through adsorption or denaturation of the proteins. Thus, it is generally necessary to alter the chemistry at the capillary wall to achieve efficient protein separations.

Numerous strategies have been developed to deactivate the capillary surface. One early approach was described in Analytical Chemistry, 1988, 60, 2322-2328, which uses very low pH buffer solutions. However, many proteins are denatured under these conditions. Another approach to minimize protein adsorption is exhibited in Journal of Chromatography, 1989, 478, 63-70, which employs high ionic strength buffers to electrostatically shield the protein from the charged capillary surfaces. However, the high conductivity of such buffers necessitates the use of low voltages and capillaries of small diameter to provide adequate dissipation of the Joule heating and avoid thermal denaturation of the protein.

Isoelectric focusing (IEF) is arguably the highest resolution technique for peptide and protein separations. Capillary isoelectric focusing (CIEF) is a miniaturized approach to carry out IEF in capillaries, and fused silica is the most common materials used for CIEF capillaries. One major problem encountered in CIEF is the adsorption of protein molecules to the capillary walls. The dominant mechanism of protein adsorptions is the electrostatic interaction between positively charged residues of the proteins and the negatively charged silanol groups which are intrinsic to silica surfaces. Protein adsorption deteriorates the resolution and contributes to the irreproducibility of the separations. Electroosmotic flow (EOF) is generally unwanted because it moves the ampholyte and the protein sample out of the CIEF capillary during IEF.

Among the various approaches, the following two are the most popular ones to address the above problems: (a) dynamic coating by small ionic, zwitterionic, or nonionic molecules and especially by low concentrations of certain water-soluble nonionoic polymers, and (b) permanent coating with materials chemically bonded to the surface or otherwise immobilized as films on the capillary walls. The dynamical coatings usually suffer from limited stability and require repeated replenishment for effective operation. As mass spectrometry (MS) becomes the dominant technique with which protein mixtures are studied, the use of dynamic coatings could be problematic. The dynamic coating additives often adversely affect the online MS analysis of proteins.

Permanent coatings are favored for protein separations because no additional materials are introduced to the sample solutions. One simple means to obtain a permanent coating is to attach a preformed polymer, such as poly(vinyl alcohols) (PVA) and hydroxypropyl cellulose (HPC), to the capillary wall. Two basic steps are involved in this coating process: (i) wetting the capillary wall with a solution containing the polymer and (ii) baking the capillary to immobilize the polymer to the wall. These steps can be repeated several times to ensure the polymer to cover the wall completely. Capillaries with these coatings can maintain a low EOF up to pH 9 and high quality CIEF separations of peptides have been demonstrated using these capillaries. However, the lifetimes of these coatings are usually limited.

More often, permanent coatings are obtained by covalently bonding the desired materials to the capillary walls. This coating protocol was first introduced by Hjerten in Journal of Chromatography, 1985, 346, 265-270. Typically, the capillary wall is first derivatized with a bi-functional reagent, such as 3-(trimethoxysilyl)propyl methacrylate, leaving an acrylic group exposed on the wall surface. The capillary is then filled with a polymerizing solution containing a monomer, such as acrylamide, and polymerization initiator, such as potassium persulfate. The free acrylic groups attached to the capillary wall serve as anchors for growing chains of polyacrylamide. Along with its various modifications, this coating has been used for many applications, but the coating quality and stability are inadequate for routine capillary isoelectric focusing of proteins. The major problem is that the polyacrylamide molecules cannot cover the capillary wall completely. The poorly covered area will adsorb proteins and create EOF. Efforts have been invested to improve the performance and stability of Hjerten coatings. Up to date, no modifications have been demonstrated to be adequate for routine high quality CIEF separations.

The reason that polyacrylamide cannot completely cover the silica surface is not fully investigated. Presumably, it is caused by the inherent nature of the silica materials. Microscopically, silica surfaces are rough, and nanometer-scale cavities are ubiquitous. The silanol groups in the cavities are much less reactive than the ones on the top. When a bi-functional reagent is introduced to a silica surface, the silanol groups on the top will react with it first. The resulting products will further hinder the reaction of the bi-functional reagent with the silanol groups in the cavities. As a result, the silanol groups in the cavities will remain unreacted (see FIG. 1a). These cavities bring two major problems: (1) polyacrylamide will not be formed on the cavity surfaces, which creates uncoated regions, and (2) OH⁻ and other nucleo-attacking groups can enter the cavity areas to cleave the polyacrylamide molecules anchored around the rims of the cavities, which makes the coating unstable.

One logic solution to improve the polyacrylamide coverage for these cavity areas is to chemically bond the polyacrylamide molecules anchored around the rims of the cavities to form some cross-linked polyacrylamide (CPA) roofs. These roofs will cover the cavity areas effectively. Applications of CPA for silica surface coating have been attempted. In the process described in the Journal of Microcolumn Separations, 1992, 4, 233-238, the inner surface of the capillary to be coated was first treated with a methanol solution containing 7-oct-1-enyltrimethoxysilane, and rinsed with methanol and methylene chloride. The capillary was loaded with a solution of 50 mg of acrylamide, 10 mg of methylene bisacrylamide and 10 mg of azobisisobutyronitrile in 4 mL of methylene chloride. The capillary was then sealed at both ends and heated from 50° C. to 120° C. at 4° C. min⁻¹ and held at 120° C. for 2 hours. In this process, because the dissolved oxygen (which suppresses the radical reaction) was not removed, high temperature was used to facilitate the polymerization reaction.

In another process described in the Journal of Chromatography A, 1993, 655, 63-72, the inner surface of the capillary to be coated was first reacted with a solution of 66% (v/v) of methacryloxypropyltrimethyoxysilane in methanol. Then a polyacrylamide gel was prepared by dissolving a mixture acrylamide and bisacrylamide (4.2% C, 10% T) in thoroughly degassed 20 mM phosphate buffer (pH 5.5). To carry out polymerization, 3 μL of 10% (v/v) aqueous ammonium peroxodisulphate solution and the same amount of 10% (w/v) N,N,N′,N′-tetramethylethylenediamine (TEMED) solution in water were added per ml of buffer. After adding peroxodisulphate and N,N,N′,N′-tetramethylethylenediamine, the polymerizing solution was homogenized using first a vortex mixer and then ultrasound for around 30 seconds each. Next, 50 μL of the polymerizing solution were injected into the above capillary. The solution was left for 1 min inside the capillary before be flushed out with nitrogen. Immediately afterwards, the capillary was heated at 140° C. for 1 min. The process of filling the capillary with polymerizing solution, flushing with nitrogen and heating was repeated three times to achieve a homogeneous coating of the inner capillary wall. In this process, although the acrylamide and bisacrylamide solution was degassed, the oxygen was re-dissolved in the solution as peroxodisulphate and TEMED were added and mixed with the acrylamide and bisacrylamide. High temperature was also used to facilitate the polymerization reaction.

The use of elevated temperatures for the polymerization reactions and the long reaction times are indications that the dissolved oxygen had not been removed effectively. In addition to the inconvenience of performing the reactions at elevated temperatures, the dissolved oxygen also interferes with the reaction between the bi-functional groups attached to the capillary surface and a monomer or an oligomer, and therefore, degrades the quality of the coating.

In another process disclosed in U.S. Pat. No. 6,074,541, preformed polymers were used to coat the capillaries. Attempts have been made to covalently bond the polymer to the silica surface by attached a bi-functional reagent to a polymer and then permitting the bi-functional reagent to reaction with the silica surface. Because these bi-functional groups are spread everywhere inside the polymer, few of them are available for the reaction. Therefore, the polymer cannot be strongly bonded to the silica surface. In addition, the un-reacted bi-functional groups may be hydrolyzed under favorable conditions. The hydrolysis products will degrade the coating quality.

In Analytical Chemistry, 1999, 71 and U.S. Pat. No. 6,596,238 B1, a semi-permanent coating process was described. In this coating process, a preformed polymer is first dissolved in a proper solvent. The solution is flushed through a capillary and then blown out, leaving some residual polymer solution on the inner wall of the capillary. The capillary is then baked to evaporate the solvent, forming a layer of polymer on the wall. Because of the surface tension, the solution can not be evenly spread out over the wall surface before and during baking. This will results in an un-evenly coated surface with many poorly-coated or un-coated spots. To reduce these poorly-coated or un-coated spots, the above coating process is usually repeated several times. Nevertheless, when the coated capillary is loaded with a background electrolyte solution for separations, the dried polymer will be re-dissolved. The poorly coated spots will be uncovered.

In this invention, a new process is disclosed to coat a solid support surface with a stable cross-linked or non-cross-linked polymer layer that is covalently bonded to the surface, and a specially designed device was used to carry out the coating process.

### SUMMARY OF THE INVENTION

An object of the invention is to provide a high-quality and stable cross-linked or linear polymer coating, preferably a cross-linked polymer coating, that is covalently linked to a solid support surface. In one embodiment, the polymerization of the coating process is performed in an oxygen-free environment. The oxygen-free environment here means an environment in which the oxygen is effectively removed, which means that not only the solution but also the head-space in the solution container are purged with a gas (e.g. helium, argon, nitrogen, etc) containing little or no oxygen.

In another embodiment, a coating process comprises: (1) the active groups (e.g. —SiOH groups for Si-based materials, —COOH for C-based materials, etc.) on a solid support surface are reacted with an bi-functional reagent, forming covalent bonds between them; (2) an oxygen-free solution comprising a monomer and a radical initiator is brought to the above functionalized surface under an oxygen-free environment so that polymer molecules are formed and covalently linked to the bi-functional groups that are covalently bonded to the solid support surface; and (3) the above polymerizing solution is removed after a polymer layer is formed on the solid surface.

In another embodiment, before the active groups on the solid surface are reacted with the bi-functional reagent, the number of active groups (e.g. —SiOH groups for Si-based materials, —COOH for C-based materials, etc.) is increased and the number of H₂O molecules on the surface is reduced.

In another embodiment, the coating process proceeds in such a manner that a solution containing at least a monomer and a radical initiator is introduced to a solid support surface rapidly after they are mixed.

Yet in another embodiment, a device, as schematically depicted in FIG. 2 that enables the coating process to be carried out in an oxygen-free environment, comprise a container that holds a monomer solution, a septum, a means to hold the septum to the container so as to achieve a air-tight seal, a gas inlet line to introduce the purging gas to the container, a vent line, a capillary with a functionalized inner surface, and at least one inlet line to add the initiator reagent. In another embodiment, the surface-functionalized capillary is replaced with a piece of tubing leading to a functionalized solid support surface.

In additional embodiment, a device, which enable the coating process to be carried out in an oxygen-free environment, comprises an oxygen-free monomer solution, an oxygen-free radical initiator solution, a solid support with a functionalized inner surface, and three fluidic channels that forms a “T-shaped” or a “Y-shaped” conduit in which the oxygen-free monomer solution and the oxygen-free initiator solution are brought together via two of the channels and the mixture solution is sent to the functionalized-surface of the solid support via the third channel.

In another embodiment, the said monomer solution further comprises a cross-linking reagent.

Yet in additional embodiment, an apparatus for capillary zone electrophoresis, capillary gel electrophoresis, and capillary isoelectric focusing comprises a capillary whose inner surface is coated with a polymer according to the above disclosed coating process, a high voltage power supply, an anode reservoir and a cathode reservoir that enable the application of a high voltage across the capillary, and a detector to monitor the separated components.

In another embodiment, a capillary, used to transport molecules from one location (e.g. the exit of a high performance liquid chromatograph column, the exit of a capillary electrochromatograph column, a sample container, etc.) to another location (e.g. the sample entrance of a mass spectrometer, a target plate, another sample collection container, etc.), has an inner surface coated with a polymer using the above disclosed coating process.

### BRIEF DESCRIPTION OF THE DRAWINGS

FIG. 1. Silica surface coated with linear polyacrylamide vs cross-linked polyacrylamide. (a) Incompletely covered silica surface with linear polyacrylamide coating; (b) Completely covered silica surface with cross-linked polyacrylamide coating.

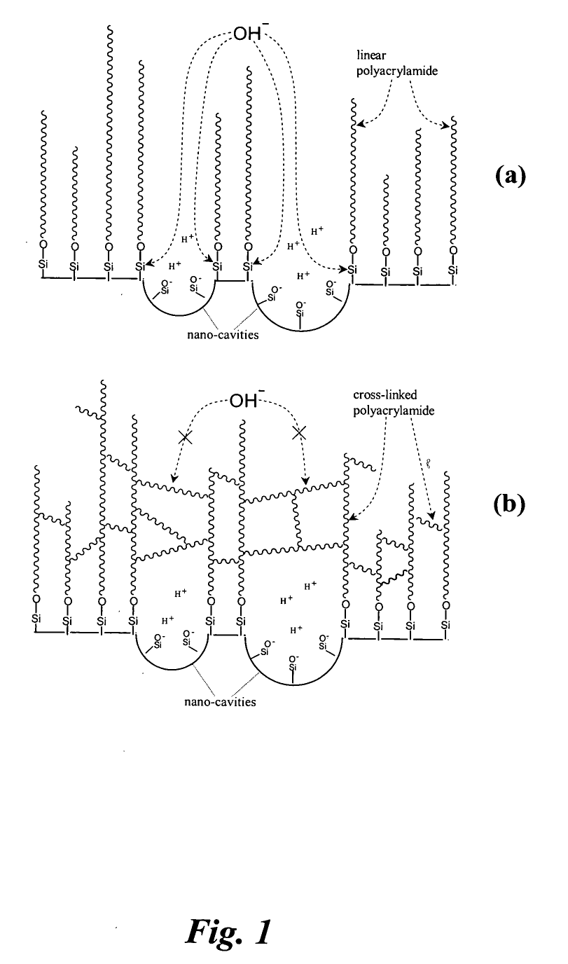

FIG. 2. Device for preparation of cross-linked polyacrylamide coatings.

FIG. 3. Effect of in-capillary polymerization time on coating performances.

FIG. 4. CIEF separation using cross-linked polyacrylamide coated capillary.

FIG. 5. Separation reproducibility of CPA-coated capillary. (a) Reproducibility of CIEF separations. (b) Reproducibility of CZE separations.

FIG. 6. Stability comparison between CPA and HPC coatings.

FIG. 7. Stability comparison between CPA and LPA coatings.

FIG. 8. CGE separation of proteins using a CPA-coated capillary.

FIG. 9. CZE separation of proteins using a CPA-coated capillary.

FIG. 10. CGE separation of BVA trypsin-digests using a CPA-coated capillary.

### DETAILED DESCRIPTION OF THE PREFERRED EMBODIMENTS

The invention is directed to modifying the properties of a solid support surface for transporting and separating components in a fluid stream in contact with such surface. In one embodiment, the support surface comprises the inner wall of a conduit such as a capillary channel for fluid transportation or capillary electrophoresis or capillary electrochromatography or capillary liquid chromatography or supercritical fluid chromatography or gas chromatography. In another embodiment, the solid support surface comprises the particulate packing of a flow-through particle bed used for liquid chromatography or capillary electrochromatography or supercritical fluid chromatography or gas chromatography.

An object of the invention is to provide a polymer coating that is covalently linked to a solid support surface. In one embodiment, a coating process comprises: (1) the active groups (e.g. —SiOH groups for Si-based materials, —COOH for C-based materials, etc.) on a solid support surface are reacted with an bi-functional reagent, forming covalent bonds between them; (2) an oxygen-free solution comprising a monomer and a radical initiator is brought to the above functionalized surface under an oxygen-free environment so that polymer molecules are formed and covalently linked to the bi-functional groups that are covalently bonded to the solid support surface; and (3) the above polymerizing solution is removed after a polymer layer is form on the solid surface.

In another embodiment, before the active groups on the solid surface are reacted with the bi-functional reagent, the number of active groups (e.g. —SiOH groups for Si-based materials, —COOH for C-based materials, etc.) is increased and the number of H₂O molecules on the surface is reduced. Specifically, the increase of the number of active groups is achieved by first cleaning the impure substances on the solid surface, and then hydrolyzing the Si—O—Si bonds on the surface of a Si-based material, or by oxidizing the C—H, C—C, and/or C—O bonds for a C-based material. The examples of Si-based materials include silicon, quartz, silica, glass, and ceramic. Other material like alumina, titania, thoria, beryllia or zirconia can be treated as a Si-based material to increase the number of active groups. The Si—O—Si bond is, of course, changed to M-O-M bond, where the M stands for an element other than Si. The examples of C-based materials include polycarbonate, poly(methyl methacrylate) (PMMA), polystyrene, nitrocellulose, poly(ethylene terephthalate) (PET or Melinex), and poly(tetrafluoroethylene) (Teflon). Polydimethylsiloxane (PDMS) can be considered to be a Si-based material, but the active groups (—COOH) are often created through oxidation of the C—H bonds.

In another embodiment, the methods for cleaning or removing the impure substances on a solid support surface include dry-cleaning (e.g. plasma etching, vacuum evaporation, and heating, etc.), and wet-cleaning (e.g. washing with an organic solvent, washing with a detergent solution, washing with an acidic solution, washing with a basic solution, etc.). Hydrolyzing the Si—O—Si bonds is carried out by reacting the surface with OH⁻, while oxidizing the C—H, C—C, and/or C—O, bonds is achieved by reacting the surface with oxygen plasma. The reduction of the number of H₂O molecules on the surface is realized by rinsing the surface with a water absorbing solution (e.g. acetoneitrile), or purging with a dry gas (e.g. helium), or heating at a medium-high temperature of preferably less than 300° C., more preferably less than 150° C.

In another embodiment, the bi-functional reagent contains two functional groups. One functional group is used to covalently bond the bi-functional molecule to an active group on a solid support surface, and the other is used to covalently link the bi-functional molecule to a polymer molecule. After a bi-functional molecule is covalently bonded to a solid surface, it is often referred as to a bi-functional group.

In another embodiment, the oxygen-free environment is an environment in which oxygen is effectively removed. It is obtained by purging both the solution and the headspace in the solution container with a gas (e.g. helium, argon, nitrogen, etc) containing little or no oxygen, and maintaining the solution and the headspace in such an oxygen-removed environment. The little oxygen in the purging gas means an oxygen concentration of less than 1% (v/v), preferably less than 0.1%, more preferably less than 1 part per million. In particular embodiment, the purging time is longer than 1 second, preferably longer than 30 seconds, more preferably between 5 min and 60 min.

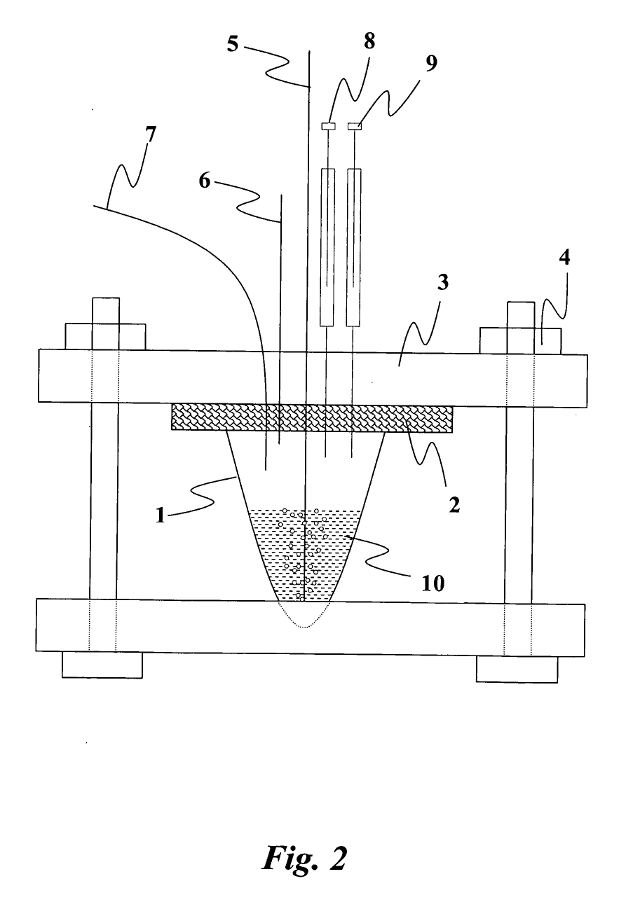

Yet in another embodiment, a device as schematically depicted in FIG. 2 is constructed to enable the polymerization process to be carried out in an oxygen-free environment. The device comprises a container holding a monomer solution, a septum, a means to hold the septum to the container so as to achieve a air-tight seal, a gas inlet line to introduce the purging gas to the container, a vent line, a surface-functionalized capillary or a piece of tubing leading to a functionalized solid support surface, and at least one inlet line to add the initiator reagent. In FIG. 2, label 1 indicates a solution container; label 10 indicates a monomer solution; label 2 indicates a septum; labels 3 and 4 indicate a means to hold the septum to the container so as to achieve a air-tight seal, label 5 indicates an inlet line for a purging gas introduction; label 6 indicates a vent line; label 7 indicates a surface-functionalized capillary or a piece of tubing leading to a functionalized solid support surface, and labels 8 or 9 indicate micro syringes for radical initiator reagent introduction.

In additional embodiment, another device is used to carry out the polymerization process in an oxygen-free environment. The device comprises an oxygen-free monomer solution, an oxygen-free radical initiator solution, a solid support with a functionalized inner surface, and three fluidic channels that forms a “T-shaped” or a “Y-shaped” conduit in which the oxygen-free monomer solution and the oxygen-free initiator solution are brought together via two of the channels and the mixture solution is sent to the functionalized-surface of the solid support via the third channel.

The polymerization reaction of a coating is usually a radical chain reaction. Any dissolved oxygen can terminate this reaction. This is why the oxygen in the monomer solution needs to be removed before the polymerization is started. After the oxygen is removed, a typical coating protocol involves adding a radical initiator to the monomer solution, mixing the initiator and the monomer, and introducing the mixture solution to the capillary to be coated. All these operations are performed in an ambient environment and oxygen can easily be re-dissolved in the mixture solution. Due to the uncontrolled nature of oxygen re-dissolution, the polymerization reaction and the coating process become unpredictable and irreproducible. The above problem can be addressed by carrying out the polymerization process in an oxygen-free environment.

In another embodiment, the coating process proceeds in such a manner that the solution containing a monomer and a radical initiator is introduced to a functionalized surface rapidly after the initiator and the monomer are mixed. Preferably, the mixture solution is introduced to the activated surface in less than 5 min after the initiator and the monomer are mixed. More preferably, the mixture solution is introduced to the activated surface in less than 1 min after the initiator and the monomer are mixed. More preferably, the mixture solution is introduced to the activated surface in less than 10 seconds after the initiator and the monomer are mixed.

Ideally, a coating process should permit the polymer chains to grow uniformly on all bi-functional groups on a solid support so that a smooth and dense layer of polymer could be formed. Unfortunately, this never happens. The monomer attachment to a bi-functional group is a random process. Initially, all bi-functional groups have equal opportunities to grow. Once one of the bi-functional groups is attached to a monomer, it poses some steric hindrance to the neighboring bi-functional groups. As a result, the extended bi-functional group will have a tendency to grow faster than its neighboring bi-functional groups. This is referred as to “the longer molecule grows faster” effect, which could be the major cause for the rough polyacrylamide coatings as mentioned in Analytical Chemistry, 1998, 70, 4023-4029. This effect becomes more pronounced if the polymerization solution is brought to the bi-functional groups after a significant amount of oligomers (short-chain polymers) has been formed. Once a bi-functional group is attached to such a preformed oligomer, this bi-functional group becomes significantly longer than its surrounding ones. This large molecule creates increased hindrance to its neighboring bi-functional groups and “the long molecule grows faster” effect will be increasingly promoted. Therefore, it is beneficial to introduce the mixture solution to capillary before large oligomers are formed. The devices disclosed in this invention enable the introduction of the mixture solution into a capillary rapidly after the radical initiator is added.

In another embodiment, the concentration of the initiator is decreased to reduce the formation of large oligomers before the polymerizing solution is introduced to the functionalized surfaces to be coated.

In additional embodiment, the above said monomer solutions further comprise a cross-linking reagent. The concentration of the monomer and the concentration of the cross-linking reagent can change independently. Preferably, the monomer concentration is less than 30%, more preferably less than 10%. The concentration of the cross-linking reagent is preferably less than 10%, more preferably less than 2%. In a particular embodiment when the monomer concentration is 0%, the polymer coating is produced by the cross-linking reagent only. Normally, the monomer concentration is higher than the cross-linker concentration.

The growth rate of polymer molecules on the bi-functional groups depends mainly on the concentrations the monomer, the cross-linking reagent and the radical initiator and the reaction temperature. High concentrations of these components and an elevated reaction temperature will accelerate the polymerization. In one embodiment, at least one of the components is controlled to be low to obtain a slow growth rate of the polymer molecules. Preferably the concentration of the monomer is controlled to be less than 30%, more preferably less than 10%. The concentration of the cross-linking reagent is preferably less than 10%, more preferably less than 2%. In another embodiment, the reaction temperature is controlled to be the ambient temperature or lower than the ambient temperature to obtain a slow growth rate of the polymer molecules. In particular embodiment, the polymerization reaction is controlled to be slow before the polymerizing solution is brought in contact with the functionalized surface. After the polymerizing solution is in contact with the functionalized surface, the reaction is accelerated, for example, by heating the polymerizing solution and/or the functionalized surface.

In additional embodiment, the bi-functional reagent is a reagent that comprises two functional groups and a radical stabilizing moiety. One functional group is used to covalently bond the reagent to the solid support surface. The other functional group is used to form a radical for polymerization reaction. The radical stabilizing moiety is a structure (e.g. —C₆H₄—CH₂. or —CH═CH—CH₂.) that stabilizes the radical. The following presents two general forms of this type 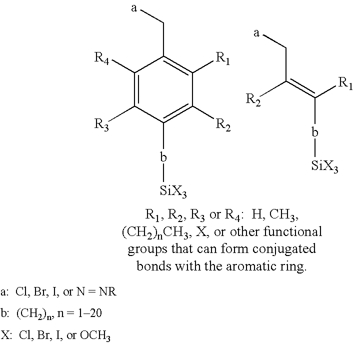
of reagents. One specific example of these reagents is 1-trichlorosilyl-2-(m-p-chloromethylphenyl)-ethane. After such a reagent is attached to a solid support surface, the bi-functional groups on the solid support surface are the only sites that will initiate polymerization reactions.

Yet in additional embodiment, an apparatus for capillary zone electrophoresis, capillary gel electrophoresis, and capillary isoelectric focusing comprises a capillary whose inner surface is coated with a polymer according to the above disclosed coating process, a high voltage power supply, an anode reservoir and a cathode reservoir that enable the application of a high voltage across the capillary, and a detector to monitor the separated components.

In another embodiment, a capillary, used to transport molecules from one location (e.g. the exit of a high performance liquid chromatograph column, the exit of a capillary electrochromatograph column, a sample container, etc.) to another location (e.g. the sample entrance of a mass spectrometer, a target plate, another sample collection container, etc.), has an inner surface coated with a polymer using the above disclosed coating process.

In order to illustrate the present invention, the following examples are provided.

### EXAMPLE 1

Preparation of linear polyacrylamide (LPA) coating. Bare capillaries were first washed with 1 M NaOH for 45 min, ultra-pure water and acetonitrile for 15 min each, and then dried with helium. To attach the anchoring functional reagent to the capillary wall, a solution of 0.4% (v/v) of 3-(trimethoxysilyl)propyl methacrylate and 0.2% (v/v) acetic acid in acetonitrile was flushed into the capillaries with a syringe pump at 50 μl/min for 1 h. The capillaries were then rinsed with acetonitrile and dried with helium.

FIG. 2 presents a device to carry out the polymerization reaction to produce a cross-linked polymer layer on the capillary wall. A 2-mL vial containing 1 mL solution was covered by a septum and clamed together through two ¼-inch-thick acrylic plates. On the top acrylic plate, there were five 1-mm-diameter holes through which the septum was accessible. A small recess on the bottom acrylic plate was used to secure the vial in position. Helium gas was introduced to the vial through the He-line to purge the solution, mainly to remove the dissolved oxygen. A needle punched through the septum formed the vent. S1 and S2 were two micro-syringes used to add N,N, N,N′-tetra-methyl-ethylenediamine (TEMED) and ammonium persulfate (APS, the radical initiator).

For preparations of linear polyacrylamide coatings, the solution in the vial contained 4% of acrylamide (AA). After the solution was purged with helium for about 30 min, 1 μL of 10% APS and 1 μL of TEMED were added to the solution through S1 and S2. Mixing was carried out automatically as the purging helium bubbled up. Promptly (<5 s) after the APS and TEMED were mixed with acrylamide, the bi-functionalized capillary was inserted into the polymerizing solution so that the solution was pressured into this capillary. The helium pressure was controlled to be about 20 psi at this stage. The polymerization proceeded as the solution was flushed through the capillary. After the solution was flushed through the capillary for 10 min, the capillary tip was taken out of the polymerizing solution and quickly flushed with de-ionized water.

### EXAMPLE 2

Preparation of cross-linked polyacrylamide (CPA) coatings. The process is the same as described in Example 1, except that the vial in FIG. 2 contained 3-4% of acrylamide (AA) and 0.003-0.03% N,N′-methylene-bis-acrylamide (Bis), and the capillary tip was taken out of the polymerizing solution and quickly flushed with de-ionized water after the polymerizing solution was flushed through the capillary for 4 min, 6 min, 8 min, or 10 min.

### EXAMPLE 3

CIEF Separations. The CIEF separations were performed using a capillary with a total length of 40 cm (an effective length of ca. 36 cm) and an inner diameter of 50 μm, unless otherwise indicated. 10 mM of phosphoric acid and 20 mM of sodium hydroxide were respectively used as anolyte and catholyte. The solution levels in the anolyte and catholyte reservoirs were carefully adjusted to be at the same height. Right before a CIEF separation, a protein sample was mixed with pharmalyte and diluted with water to make the final solution contain 1.8% (w/v) pharmalyte, 7 M urea and a desired amount of protein. After the CIEF capillary was filled with the above protein-pharmalyte mixture, isoelectric focusing was conducted by applying a voltage of 20 kV across the capillary for 20 min. The focused bands were hydrodynamically mobilized to the UV/V is detector after the anolyte reservoir was raised by 2.7 cm. The high voltage was kept on during the mobilization. Between runs, the anolyte and catholyte solutions were replenished and the capillary was rinsed thoroughly with DI water.

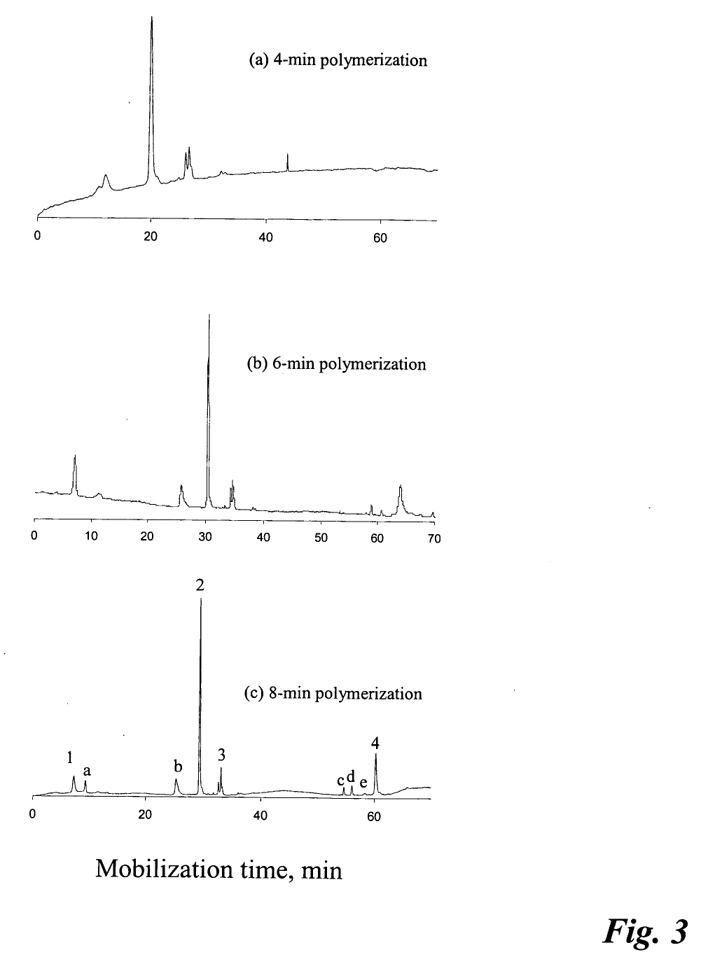

FIG. 3 presents the effect of in-capillary polymerization time on coating performances: (a) 4-min in-capillary polymerization; (b) 6-min in-capillary polymerization; (c) 8-min in-capillary polymerization. The in-capillary polymerization time means the duration after the polymerizing solution is introduced into the capillary and before the polymerizing solution is pushed out. Referring to Example 1, the solution used to coat the capillaries for this experiment contained 4% acrylamide, 0.0008% Bis, 0.01% APS and 0.1% TEMED. The protein sample and ampholyte mixture contained ca. 0.1 mg/mL of each protein, 1.8% of pharmalyte and 7 M urea. 280 nm was used to detect the protein bands as they passed across the UV/V is detector. Y-axis full scale was normalized to 100 mAU for all the separation traces. Peak identifications: 1—bovine pancreas trypsinogen (pI 9.30); 2/3—equine skeletal muscle myoglobin (pI 7.35/6.85); 4—soybeans trypsin inhibitor (pI 4.55); peaks a, b, c, d and e were decomposed products from the protein mixture.

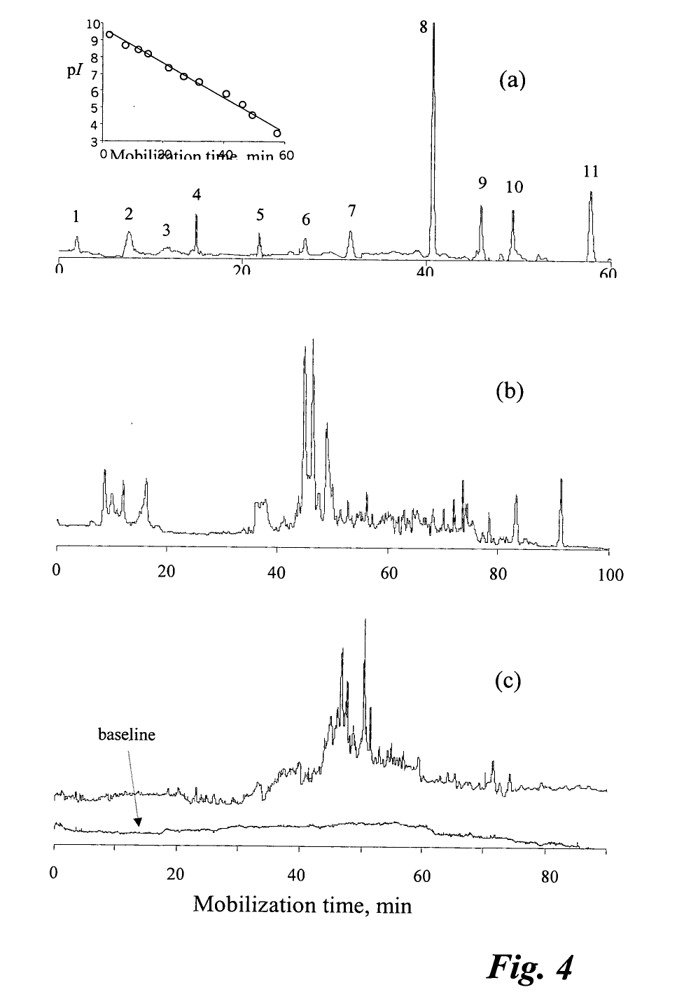

FIG. 4 presents CIEF separations using a cross-linked polyacrylamide coated capillary: (a) CIEF separation of standard protein pI markers. The ampholyte-protein mixture contained ca. 0.3 mg/mL total protein. 1—trypsinogen (pI 9.30); 2—lentil lectin-basic band (pI 8.65); 3—lentil lectin-middle band (pI 8.45); 4—lentil lectin-acidic band (pI 8.15); 5—myoglobin-basic band (pI 7.35); 6—myoglobin-acidic band (pI 6.85); 7—human carbonic anhydrase B (pI 6.55); 8—bovine carbonic anhydrase B (pI 5.85); 9—β-lactoglobulin A (pI 5.20); 10—trypsin inhibitor (pI 4.55); 11—amyloglucosidase (pI 3.50). (b) CIEF separation of bovine albumin tryptic digests. The ampholyte-protein mixture contained ca. 5 mg/mL of bovine albumin. All other conditions were the same as in FIG. 3c. Y-axis full scale was normalized to 20 mAU. (c) CIEF separation of a crude protein extract. All other conditions were the same as in FIG. 3c. Y-axis full scale was normalized to 6 mAU.

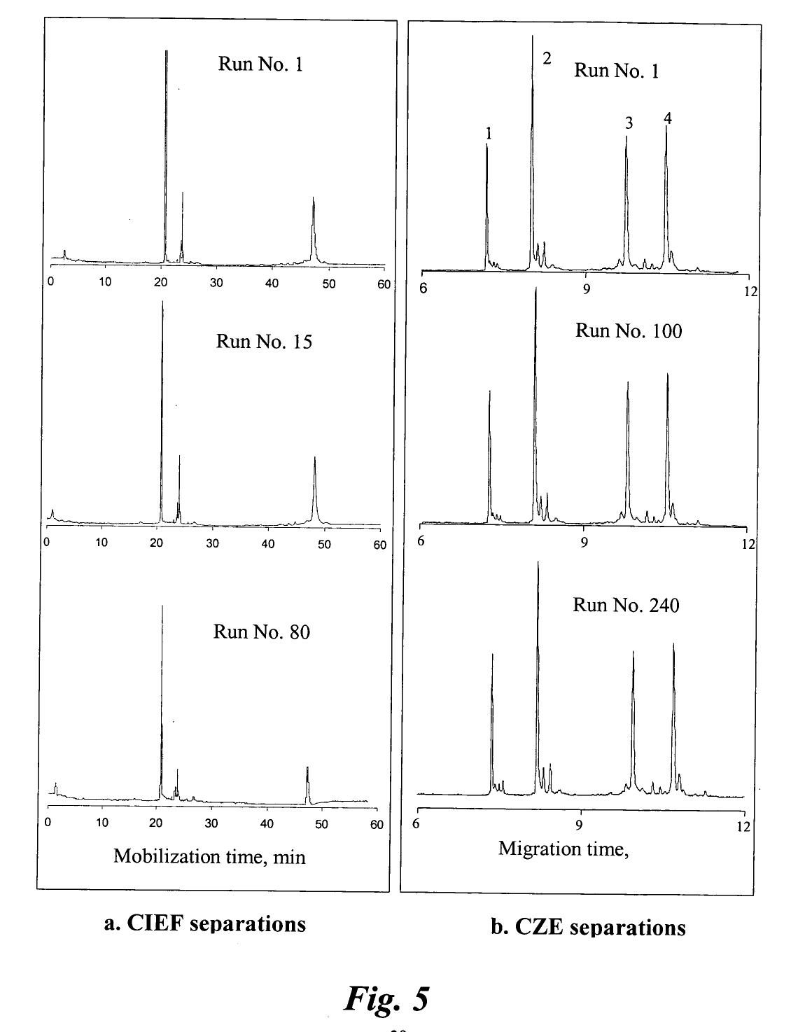

FIG. 5 presents the separation reproducibility of a CPA-coated capillary: (a) Reproducibility of CIEF separations. All other conditions were the same as in FIG. 3c. Y-axis full scale was normalized to 80 mAU. (b) Reproducibility of CZE separations. Sample: 1-cytochrome C, 2-lysozyme, 3-trypsinogen and 4-alpha-chymotrypsinogen A; 0.25 mg/mL each. Capillary: 36-cm effective length (40-cm total length) and 50 um id. Running buffer: 50 mM Tris-H₃PO₄, pH 3.25. Separation field strength: 375 V/cm. Sample injection: 20 s at a ΔH of 20 cm. Detection wavelength: 214 nm.

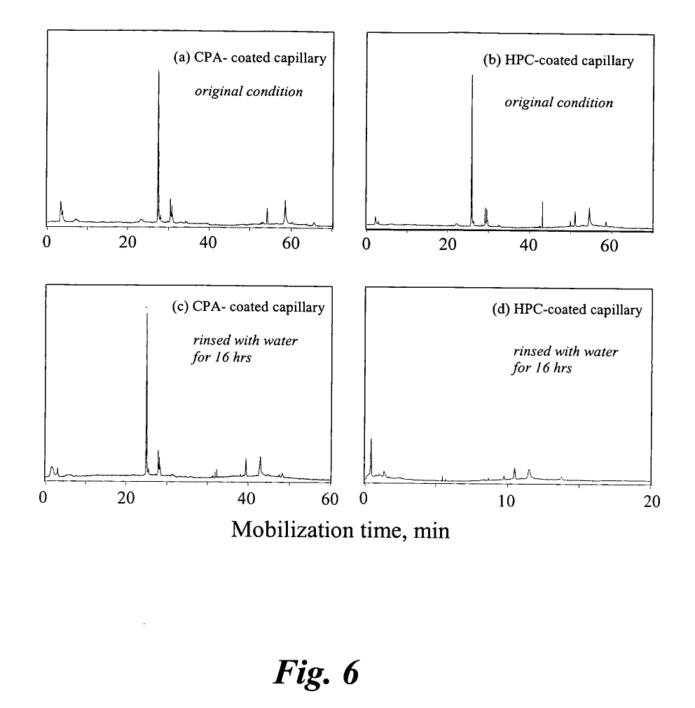

FIG. 6 presents the stability comparison between CPA and HPC coatings: (a) and (b) CIEF separations using a CPA- and a HPC-coated capillaries at their original conditions; (c) and (d) CIEF separations using the same capillaries after they were continuously rinsed with H₂O at a flow rate of 1.5 μL min⁻¹ for 16 h. The CIEF conditions were the same as in FIG. 3. Y-axis full scale was normalized to 100 mAU.

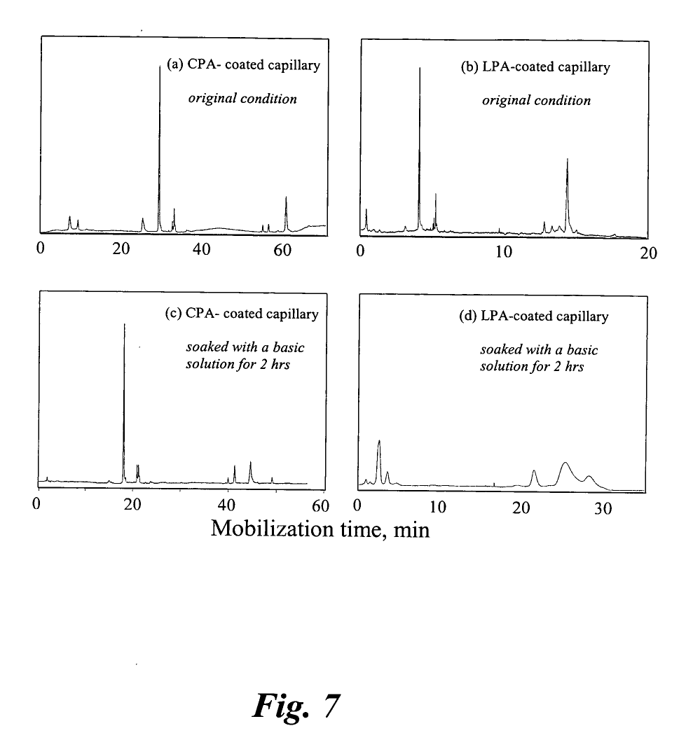

FIG. 7 presents the stability comparison between CPA and LPA coatings: (a) and (b) CIEF separations using a CPA- and a LPA-coated capillaries at their original conditions; (c) and (d) CIEF separations using the same capillaries after they were soaked in a solution containing 200 mM lysine and 200 mM arginine (pH 10.37) for 2 h. The CIEF conditions were the same as in FIG. 3. The Y-axis full scale for FIGS. 7a and 7c was normalized to 100 mAU, and that for FIG. 7b and 7d was normalized to 150 mAU since the LPA-coated capillary had an i.d of 75 μm (vs 50 μm for all other experiments).

### EXAMPLE 4

SDS-PAGE. After the SDS-sieving matrix was introduced into the separation capillary, a protein sample was electrokinectically injected with a field strength of 290 V/cm for 5 s. The same sieving matrix solution was utilized as the background electrolyte solution in both anode and cathode reservoirs. The separation was performed at the same field strength of 290 V/cm. The separated proteins were detected at 220 nm.

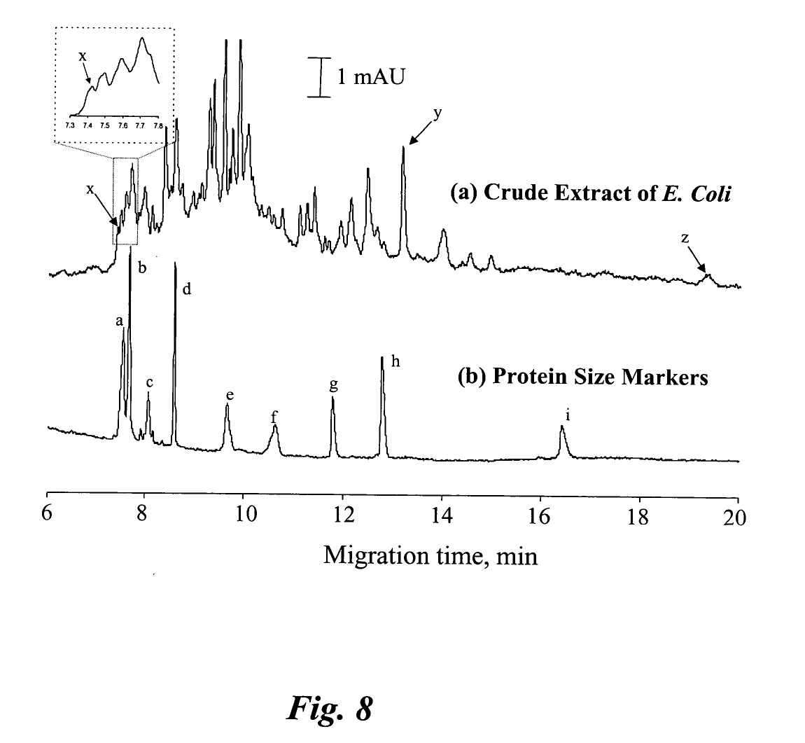

FIG. 8 presents the separation results of a crude extract of E. Coli: (a) Electropherogram of a crude E. Coli cell extract sample; (b) Electropherogram of a broad MW protein size marker. The separation was performed using a 75-μ-i.d., 200-μm-o.d., 34.5-cm-long (effective length: 30 cm) capillary. The inner wall of the capillary was coated with CPA as described in FIG. 3c. The samples were prepared in 3% SDS, 2% 2-Mercaptoethanol, and 0.06M Tris-0.06M TAPS at pH 8.35. Protein identification for the protein markers: a—Aprotinin (6.5 kD), b—Lysozyme (14.4 KD), c—Trypsin inhibitor (21.5 kD), d—Carbonic anhydrase (31 kD), e—Ovalbumin (45 kD), f—Serum albumin (66.2 kD), g—Phosphorylase b (97.4 kD), h—β-galactosidase (116.25 kD) and i—Myosin (200 kD).

### EXAMPLE 5

Capillary Zone Electrophoresis (CZE) Separations. The dimension of the capillary column used here had a total length of 40 cm (an effective length of ˜36 cm), 50 μm i.d. A 4-cm-long window for detection was made by scraping off the capillary polyimide coating with a razor blade. All samples were hydrodynamically injected under 20-cm height difference for 20 s. Absorbances of the separated proteins were measured at 214 nm. The running buffer was 50 mM Tris-H₃PO₄ at pH 3.25, and the voltage applied to the capillary column was 15 kV.

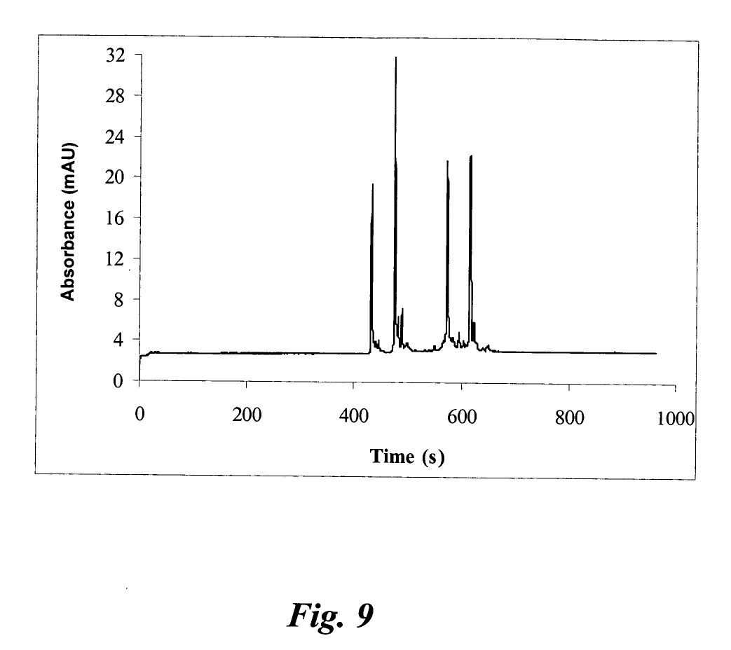

FIG. 9 presents a CZE separation of a mixture of 4 basic proteins using a CPA-coated capillary. Peak identifications: 1—cytochrome c; 2—lysozyme; 3—trypsinogen; 4—α-chymotrypsinogen A. Y-axis full scale was normalized to 30 mAU. Each protein concentration was 0.25 mg/mL. The number of theoretical plates for cytochrome c is 1.3 million per meter.

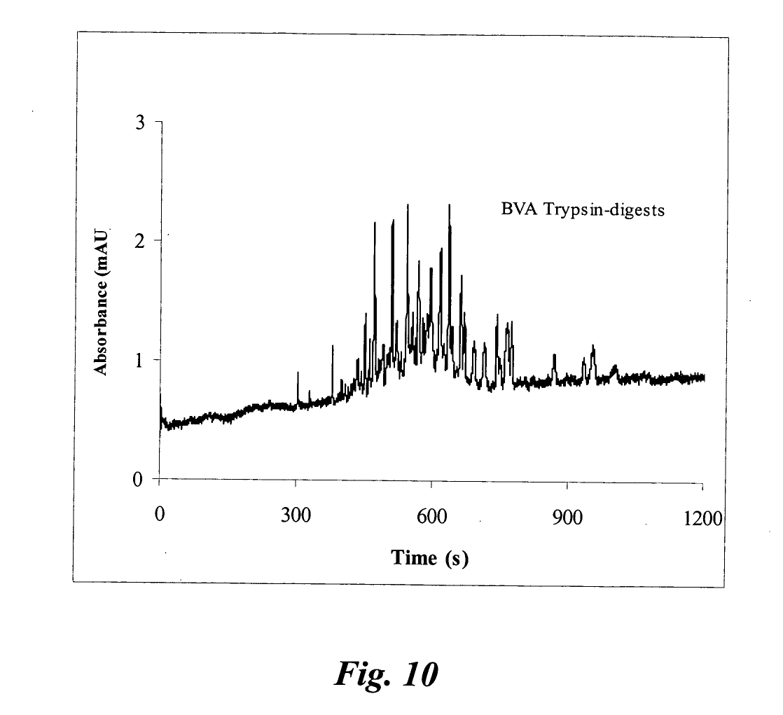

FIG. 10 presents a CZE separation of bovine albumin tryptic digests using a CPA-coated capillary. The sample contained ˜0.5 mg/mL of bovine albumin. Other conditions are the same as in FIG. 9.

1. A process for producing a layer of polymer that is covalently linked to a solid support surface, comprises:
the solid support surface is functionalized by reacting the active groups on the solid support surface with a bi-functional reagent, forming covalent bonds between active groups and the bi-functional reagent,
a monomer solution and the headspace in the solution container are purged with a gas containing little or no oxygen to removed the oxygen in the solution and the headspace,
the said monomer solution is mixed with a radical initiator under an oxygen-removed environment, forming a mixture solution,
the mixture solution is rapidly brought to the above functionalized surface under an oxygen-removed environment so that polymer molecules are formed and covalently linked to the bi-functional groups that are covalently bonded to the solid support surface, and
the above mixture solution is removed after a layer of polymer is formed on the solid surface.

2. A process of claim 1 further comprises a surface activation step before the active groups on the solid surface are reacted with the bi-functional reagent, which comprises:
the number of active groups on the solid surface is increased by cleaning and hydrolyzing the solid surface, and
the number of H₂O molecules on the surface is reduced by rinsing the surface with a water absorbing solution, or purging with a dry gas, or heating.

3. A process of claim 1, wherein the purging gas is helium containing less than 1% oxygen.

4. A process of claim 1, wherein the purging gas is argon containing less than 1% oxygen.

5. A process of claim 1, wherein the purging gas is nitrogen containing less than 1% oxygen.

6. A process according to claim 1, wherein the mixture solution is brought to the functionalized surface in less than 5 min after the initiator and the monomer are mixed.

7. A process according to claim 1, wherein the mixture solution is brought to the functionalized surface in less than 1 min after the initiator and the monomer are mixed.

8. A process according to claim 1, wherein the mixture solution is brought to the functionalized surface in less than 10 seconds after the initiator and the monomer are mixed.

9. A process according to claim 1, wherein the monomer solution further comprises a cross-linking reagent.

10. A process according to claim 9, wherein the monomer concentration is less than 30%.

11. A process according to claim 9, wherein the concentration of the cross-linking reagent is less than 5%.

12. A process according to claim 1, wherein the monomer is a cross-linking reagent.

13. A process according to claim 1, the bi-functional reagent is a reagent that comprises:
one functional group that forms a covalent bond between the bi-functional reagent and the active groups on the solid support surface, and
another functional group that forms a covalent bond between the bi-functional reagent and the polymer.

14. A process according to claim 1, the bi-functional reagent is a reagent that comprises:
one functional group that forms a covalent bond between the bi-functional reagent and the active groups on the solid support surface,
another functional group that forms a radical for polymerization reaction, and
a radical stabilizing moiety that stabilizes the radical.

15. A capillary produced by the process of claim 1.

16. A device for carrying out the polymerization according to claim 1 under an oxygen-removed environment, comprises:
a container holding a monomer solution,
a septum,
a means to hold the septum to the container so as to achieve a air-tight seal,
a gas inlet line to introduce the purging gas to the container,
a vent line,
a surface-functionalized capillary or a piece of tubing leading to a functionalized solid support surface, and
at least one inlet line to add an initiator reagent.

17. A device for carrying out the polymerization according to claim 1 under an oxygen-removed environment, comprises:
an oxygen-removed monomer solution,
an oxygen-removed radical initiator solution,
a solid support with a functionalized inner surface, and
three fluidic channels that forms a “T-shaped” or a “Y-shaped” conduit in which the oxygen-removed monomer solution and the oxygen-removed initiator solution are brought together via two of the channels and the mixture solution is sent to the functionalized-surface of the solid support via the third channel.

18. A capillary of claim 15, for capillary zone electrophoresis, capillary gel electrophoresis, and capillary isoelectric focusing, further comprises:
a high voltage power supply,
an anode reservoir and a cathode reservoir that enable the application of a high voltage across the capillary for component separation, and
a detector to monitor the separated components.

19. A capillary of claim 3, for molecule transportation, further comprises:
an object that contains or produces analytes that are transported via the capillary, and
an object that accepts the said analytes from the capillary.
